(19) United States
(12) Patent Application Publication
(10) Pub. No.: US 2007/0227141 A1
(43) Pub. Date: Oct. 4, 2007

(54) Multi-stage jacket water aftercooler system

(76) Inventors: Jiubo Ma, Dunlap, IL (US); Sen Hwee Lim, Dunlap, IL (US); Nilkanth Dinesh Desai, Peoria, IL (US); Kent Clark Bates, Chillicothe, IL (US); Ajey Janardan Kulkarni, Saint Ismier (FR); Ashok Nanjundan, Neelankarai (IN); James Carl Durand, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/394,272

(22) Filed: Mar. 31, 2006

(51) Int. Cl. F02B 29/04; F02B 33/44

(52) U.S. Cl. 60/599; 60/605.1; 60/612

(57) ABSTRACT

An air intake system for a power source can include a first jacket water aftercooler, a second jacket water aftercooler, a compressor system, and an air intake for the power source. The first jacket water aftercooler and the second jacket water aftercooler can be located fluidly upstream from the air intake for the power source and fluidly downstream from the compressor system.

### TECHNICAL FIELD

The present disclosure relates generally to an air intake system for an internal combustion power source and specifically to an air intake system for an internal combustion power source implementing a multi-stage jacket water aftercooler system.

### BACKGROUND

Internal combustion engines, including diesel engines, gasoline engines, gaseous fuel-powered engines, and the like, may exhaust a complex mixture of air pollutants including, for example, gaseous compounds and solid particulate matter. These air pollutants, which sometimes originate as components or natural impurities in fuel, can affect exhaust emissions, damage emission control devices, and increase secondary pollutant formation in the atmosphere.

Diesel fuels, for example, often contain sulfur and other substances that, at times, convert to potentially corrosive and environmentally unfriendly byproducts. During combustion, sulfur is oxidized to sulfur dioxide (SO₂) and minute amounts of sulfur trioxide (SO₃). The resulting SO₃ reacts with water vapor to form sulfuric acid. Once the exhaust gas cools, the resulting SO₂ likewise reacts with water condensate to form sulfuric acid. The sulfuric acid subsequently condenses downstream in the exhaust system to produce an acidic condensate. NOx species in the exhaust gas can also be converted to nitric acid, which can form acidic condensates.

Various emission technologies including exhaust gas recirculation (EGR) systems and air induction systems, for example, have been developed to improve combustion efficiency and reduce harmful emissions of internal combustion engines. After-treatment technologies for aftercooling the engine intake air, including an air-to-air aftercooler (ATAAC), have been developed to improve combustion and reduce NOx emissions. ATAACs are useful in reducing smoke and other engine emissions by cooling charged air and exhaust gas before it enters an engine intake manifold. ATAACs can also help to lower combustion temperatures and, indirectly, reduce thermal stress on the engine.

Cooling of exhaust gases, however, can result in the formation of corrosive condensates that affect the durability and performance of emission system components. For example, acidic condensates resulting from the cooling of exhaust gases can affect the performance and durability of combustion engine systems and components, such as for example, clean gas induction (CGI) systems, EGR systems, aftercooler systems, and supercharged or turbocharger compressors systems.

Components of the ATAAC, for example, are subject to corrosion and secondary wear from corrosion byproducts and acidic condensates. Moreover, typical ATAACs are constructed from materials like aluminum, making ATAACs especially susceptible to corrosion from acidic condensates.

Consequently, there is a need for after-treatment technologies that reduce harmful emissions of internal combustion engines and improve combustion efficiency, but with less susceptibility to corrosion.

One method of cooling diesel engine exhaust gases in an EGR system is described in U.S. Pat. No. 5,607,010 (“Schönfeld et al.”). Schönfeld et al. describes a heat exchanger arrangement where the cooling of the hot exhaust air is carried out in at least two successive steps, in respective serially arranged heat exchangers, upstream from a fresh air supply inlet, and prior to entering the compressor. Schönfeld et al. discloses that the hot gasses exiting the exhaust gas turbine first reach a series of heat exchangers before subsequently being compressed. The series of heat exchangers disclosed in Schönfeld et al., however, are employed in an engine gas recirculation system, rather than the air intake system. Additionally, Schönfeld et al. does not provide for a system, method, or apparatus employing a multi-stage jacket water after-cooler design for an air intake system.

The present disclosure is directed towards overcoming one or more of the problems set forth above.

### SUMMARY OF THE INVENTION

In one aspect, the present disclosure is directed to an air intake system for a power source. The air intake system can include a first jacket water aftercooler and a second jacket water aftercooler. The air intake system can further include a compressor system and an air intake for the power source. The first and the second jacket water aftercooler can be fluidly upstream from the air intake for the power source, and fluidly downstream from the compressor system.

In another aspect, the present disclosure is directed to a method for cooling the airflow fluidly upstream of an air intake for a power source. The method includes introducing a mixture of pressurized air and recirculated exhaust gas to an aftercooling heat exchanging system via one or more pressurized air and recirculated exhaust gas passages. The one or more exhaust gas passages can be fluidly coupled to the heat exchanging system, and the exchanging system can include a first jacket water aftercooler and a second jacket water aftercooler. The method can further include aftercooling the mixture with the heat exchanging system and introducing the aftercooled mixture to an air intake for the power source.

In another aspect, the present disclosure is directed to a machine. The machine can include a power source and an air intake system for the power source. The air intake system for the power source can further include a first jacket water aftercooler and a second jacket water aftercooler. The air intake system can further include a compressor system and an air intake for the power source. The first and the second jacket water aftercooler can be fluidly upstream from the air intake for the power source, and fluidly downstream from the compressor system.

### BRIEF DESCRIPTION OF THE DRAWINGS

FIG. 1 provides a diagrammatic representation of an airflow system including an air intake system according to an exemplary disclosed embodiment.

FIG. 2 provides a diagrammatic representation of a cooling fluid flow system for a machine air intake system, according to an exemplary disclosed embodiment.

FIG. 3 illustrates a machine according to an exemplary disclosed embodiment.

### DETAILED DESCRIPTION

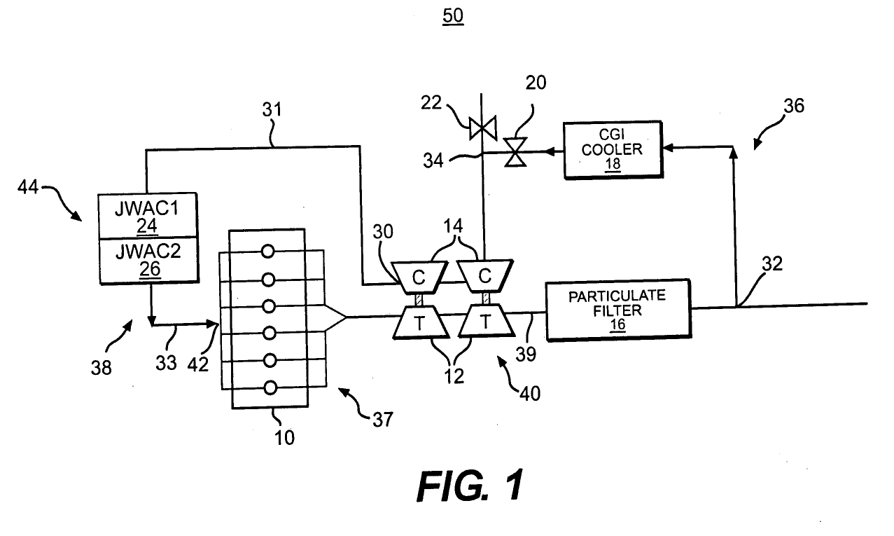

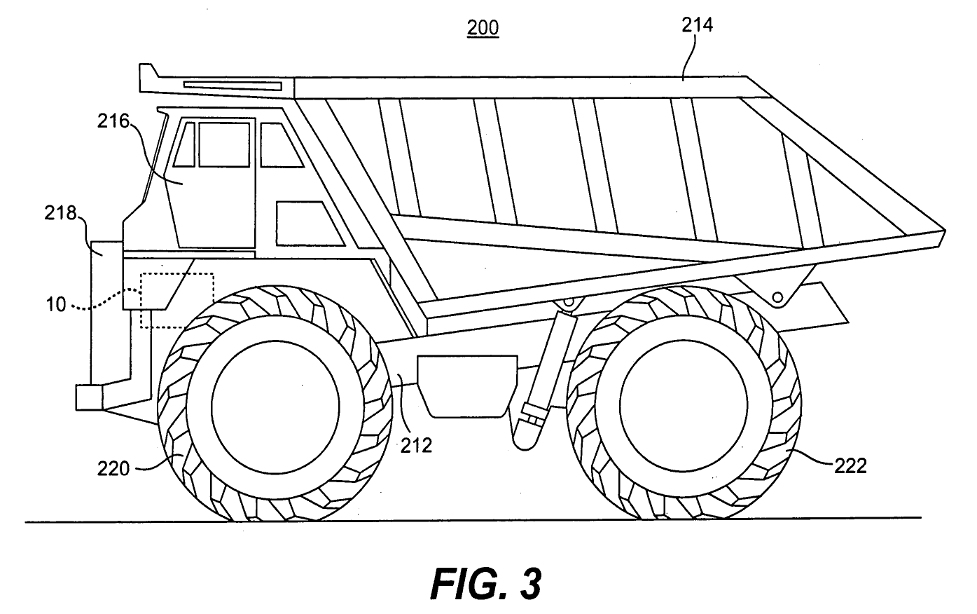

FIG. 1 illustrates an airflow system 50, including an air intake system, according to an exemplary disclosed embodiment, for a machine (FIG. 3). Airflow system 50 can include a power source 10, a clean gas induction (CGI) system 36, an exhaust system 37, and an air intake system 38 including an aftercooler 44.

Examples of power source 10 may include an engine such as, for example, a diesel engine, a gasoline engine, a gaseous fuel-powered engine, natural gas engine, or any other engine apparent to one skilled in the art. Power source 10 may alternatively include another source of power such as a furnace or any other suitable source of power.

Air intake system 38 can include an induction valve 22, aftercooler 44, one or more fluid passageways 31 and 33, and a power source air intake port 42. Air intake system 38 can also include an intake manifold, an intake port, and at least one turbocharger (including at least one turbine 12 and at least one compressor 14). In an exemplary embodiment, at least one turbocharger can be in fluid communication with air intake port 42, air intake system 38, CGI system 36, and an exhaust system 37, and configured to provide a portion of exhaust gas from the exhaust system 37 to the airflow system 50.

In an exemplary embodiment, a compressor system 40 can be configured to provide pressurized air and recirculated exhaust gas from exhaust system 37 and CGI system 36 to air intake system 38. Air intake system 38 can be configured for introducing pressurized air and recirculated exhaust gas into one or more combustion chambers of power source 10. In an exemplary embodiment, at least a portion of exhaust gas can be taken from an exhaust stream after it exits a particulate filter 16. The gas can be cooled by routing it through a CGI cooler 18, followed by directing it through air intake system 38, and lastly directing it into a power source 10, via air intake port 42. In route, the gas can be mixed with ambient air, passed through at least one compressor 14, and aftercooled using an aftercooler 44. The charged air exiting aftercooler 44 can be subsequently routed into air intake port 42.

Power source 10 can be associated with air intake system 38. Power source 10 can include, for example, one or more combustion chambers, one or more air intake ports 42, an exhaust system 37, and one or more exhaust ports. Power source 10 can further include an air intake valve controllably movable to open and close the air intake port 42. Power source 10 can also include an airflow system 50 including at least one turbocharger (including at least one turbine 12 and at least one compressor 14) in fluid communication with one or more air intake ports 42, and a CGI system 36 configured to provide a portion of exhaust gas from the exhaust system 37 to the airflow system 50.

Aftercooler 44 can include one or more air-to-liquid heat exchanger (e.g., jacket water aftercoolers 24 and 26). This heat exchanger may be configured to facilitate the transfer of heat to or from the air directed into power source 10. For example, aftercooler 44 may include a tube and shell type heat exchanger, a plate type heat exchanger, or any other type of heat exchanger known in the art. Aftercooler 44 can be connected to power source 10 via fluid passageway 33.

Aftercooler 44 can include a multiple-stage jacket water aftercooler including at least a first jacket water aftercooler 24 and a second jacket water aftercooler 26. Jacket water aftercoolers 24 and 26 can be configured to cool exhaust within jacket water aftercoolers 24 and 26. First jacket water aftercooler 24 can be fluidly coupled in series with second jacket water aftercooler 26. Further, first jacket water aftercooler 24 and second jacket water aftercooler 26 may be located upstream of air intake port 42 for power source 10, and downstream from compressor system 40.

In an exemplary embodiment, a mixture of pressurized air and recirculated exhaust gas can be introduced into aftercooler 44 via one or more pressurized air and recirculated exhaust gas passages (e.g., passageway 31), fluidly coupled to aftercooler system 44.

In an exemplary embodiment, aftercooler 44 can be employed in a method for cooling the airflow fluidly upstream of air intake port 42 for a power source 10 and fluidly downstream from compressor system 40. The cooling method may include introducing a mixture of pressurized air and recirculated exhaust gas to an aftercooling heat exchanging system (e.g., aftercooler 44) for cooling. The method can further include aftercooling the mixture of pressurized air and recirculated exhaust gas with the heat exchanging system. In an exemplary embodiment, the method can include introducing the aftercooled mixture to an air intake port 42 for the power source 10. The introduction of a mixture of pressurized air and recirculated exhaust gas to an aftercooling heat exchanging system can include controllably introducing a quantity of exhaust gas from an exhaust CGI system. The CGI system can include, for example, a low pressure loop CGI system.

The method can further include having the first jacket water aftercooler fluidly coupled in series with the second jacket water aftercooler. In an exemplary embodiment, the method can include maintaining a pressure differential of no more that a predetermined amount over a portion of the air induction system 38. In an exemplary embodiment, the predetermined pressure differential may be no more than about 15 KPa between air intake port 42 for power source 10 and a point 30 fluidly downstream from a compressor system 40. In another exemplary embodiment, the predetermined pressure differential may be no more than about 13 KPa between air intake port 42 for power source 10 and a point 30 fluidly downstream from a compressor system 40.

Examples of materials useful for construction of jacket water aftercoolers 24 and 26 include stainless steel, carbon steel, brass, copper, aluminum, nickel, or alloys thereof. The surfaces of the jacket water aftercoolers 24 and 26 can further include corrosion resistant coatings, wear resistant coatings, heat resistant coatings, and the like.

Compressors 14 can be configured to compress the air flowing into power source 10. Compressor system 40 can be further configured to turbocharge the air flowing into power source 10.

Compressors 14 can be disposed in a series relationship and fluidly connected to power source 10 via passageway 31. Each of compressors 14 may include a fixed geometry compressor, a variable geometry compressor, or any other type of compressor known in the art. It is contemplated that compressors 14 may, alternatively, be disposed in a parallel relationship or that air intake system 38 may include only a single compressor 14. In an exemplary embodiment, compressor system 40 includes a two-stage compressor. It is further contemplated that compressors 14 can be omitted when a non-pressurized air intake system is desired.

It is contemplated that additional components can be included within air intake system 38 such as, for example, additional valving, one or more air cleaners, one or more waste gates, a control system, and other configurations for introducing charged air into combustion chambers of power source 10.

CGI system 36 may include an inlet port 32, at least one particulate filter 16, CGI cooler 18, a recirculation valve 20, and a discharge port 34. CGI system 36 can be configured for redirecting a portion of the exhaust flow of power source 10 from exhaust system 37 into air intake system 38.

A particulate filter 16 can be connected upstream or downstream to inlet port 32 and configured to remove particulates from the portion of the exhaust flow directed through a passageway 39. Particulate filter 16 may include electrically conductive or non-conductive coarse mesh elements. It is contemplated that particulate filter 16 may include a catalyst for reducing an ignition temperature of the particulate matter trapped by particulate filter 16, one or more elements configured to regenerate the particulate matter trapped by particulate filter 16, or both a catalyst and a capability for regenerating. The capability for regenerating may include, among other things, a fuel-powered burner, an electrically-resistive heater, an engine control strategy, and the like, or any other measure for regenerating known in the art. It is contemplated that particulate filter 16 can be omitted in some embodiments.

Inlet port 32 can be connected to exhaust system 37 and configured to receive at least a portion of the exhaust flow from power source 10. Specifically, inlet port 32 can be disposed downstream of turbines 12 to receive exhaust gases from turbines 12. It is contemplated that inlet port 32 may alternatively be located upstream of turbines 12.

An exhaust system 37 may include the capability for directing exhaust flow out of power source 10. For example, exhaust system 37 may include one or more turbines 12 connected in a series relationship. It is contemplated that exhaust system 37 may include additional components such as, for example, emission controlling devices (e.g., particulate traps, NOx absorbers, other catalytic devices, and the like), attenuation devices, or other measures for directing exhaust flow out of power source 10, that are known in the art.

Each turbine 12 can be connected to one compressor 14 and configured to drive the connected compressor 14. In particular, as the hot exhaust gases exiting power source 10 expand against blades (not shown) of turbine 12, turbine 12 may rotate and drive the connected compressor 14. It is contemplated that turbines 12 may, alternatively, be disposed in a parallel relationship or that only a single turbine 12 can be included within exhaust system 37. It is also contemplated that, in certain embodiments, turbines 12 can be omitted and compressors 14 driven by power source 10 mechanically, hydraulically, electrically, or in any other manner known in the art.

CGI cooler 18 can be fluidly connected to particulate filter 16 via a fluid passageway and configured to cool the portion of the exhaust flowing through inlet port 32. CGI cooler 18 may include a liquid-to-air heat exchanger, an air-to-air heat exchanger, or any other type of heat exchanger known in the art for cooling an exhaust flow. In an exemplary embodiment, CGI cooler 18 may include a liquid-to-air heat exchanger. It is contemplated that CGI cooler 18 can be omitted in certain embodiments.

A recirculation valve 20 can be fluidly connected to CGI cooler 18 via a fluid passageway and configured to regulate the flow of exhaust through CGI system 36. Examples of recirculation valve 20 may include a spool valve, a shutter valve, a butterfly valve, a check valve, a diaphragm valve, a gate valve, a shuttle valve, a ball valve, a globe valve, an the like, or any other valve known in the art. Recirculation valve 20 can be solenoid-actuated, hydraulically-actuated, pneumatically-actuated or actuated in any other manner.

A flow characteristic of recirculation valve 20 can be related to a flow characteristic of induction valve 22. Specifically, recirculation valve 20 and induction valve 22 may both be controlled such that an amount of exhaust flow entering air intake system 38 via recirculation valve 20 can be related to an amount of air flow entering air intake system 38 via induction valve 22. For example, as the flow of exhaust through recirculation valve 20 increases, the flow of air through induction valve 22 may proportionally decrease. Likewise, as the flow of exhaust through recirculation valve 22 decreases, the flow of air through induction valve 22 may proportionally increase.

A discharge port 34 can be fluidly connected to recirculation valve 22 via a fluid passageway and configured to direct the exhaust flow regulated by recirculation valve 22 into air intake system 38. Specifically, discharge port 34 can be connected to air intake system 38 upstream of compressors 14, such that compressors 14 may draw the exhaust flow from discharge port 34.

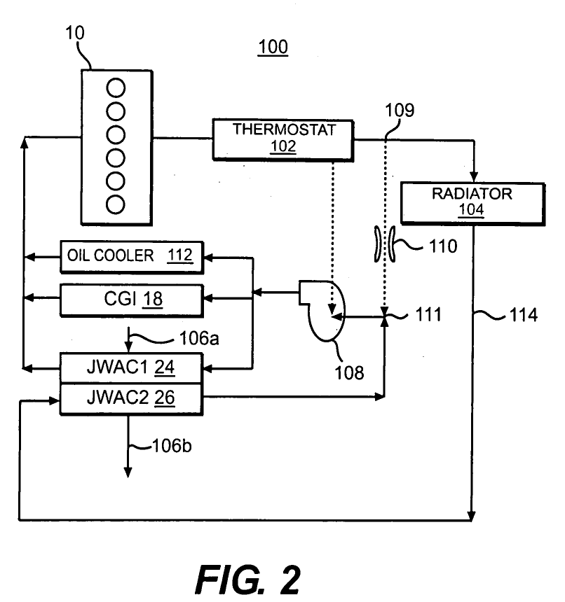

FIG. 2 illustrates a fluid flow schematic for a cooling system 100, for a machine, according to an exemplary disclosed embodiment. Cooling system 100 can include a thermostat 102, a radiator 104, a bypass point 109, a modular orifice 110, a mixing location 111, and a pump 108. Cooling system 100 can further include a liquid-cooled power source 10, liquid-cooled jacket water aftercoolers 24 and 26, a liquid-cooled CGI 18, and a liquid-cooled oil cooler 112. The cooling system components (e.g., radiator, liquid-cooled jacket water aftercoolers 24 and 26, and the like) can be configured to circulate cooling fluid (e.g., water, seawater, engine coolant, and the like). In an exemplary embodiment, flowing a coolant fluid through liquid-cooled jacket water aftercoolers 24 and 26 can regulate charged air temperatures, improving combustion and reducing emissions.

In one embodiment, power source 10 can be fluidly coupled to thermostat 102. Thermostat 102 can be fluidly coupled to radiator 104 and modular orifice 110. Radiator 104 and modular orifice 110 can be fluidly coupled to second jacket water aftercooler 26 via one or more coolant fluid passageways 114. Modular orifice 110 can be configured to control the bypass flow of coolant fluid from thermostat 102 and bypass 109, to pump 108.

Cooling fluid exiting radiator 104 may be at a lower temperature than cooling fluid exiting thermostat 102. Accordingly, liquid-cooled jacket water aftercoolers 24 and 26 can be configured to provide two-stage aftercooling. Two-stage aftercooling can be achieved by providing cooling fluid from radiator 104 to second jacket water aftercoolers 26, and by providing cooling from the thermostat 102, but that bypasses radiator 104, and from second jacket water aftercoolers 26 to first jacket water aftercoolers 24.

In another embodiment, charged air 106a may enter a liquid-cooled first jacket water aftercooler 24, followed by a liquid-cooled second jacket water aftercooler 26, and exit as charged air 106b.

Cooling system 100 can include a liquid-cooled first jacket water aftercooler 24, a liquid-cooled second jacket water aftercooler 26, a liquid-cooled CGI cooler, and a liquid-cooled engine oil cooler. In an exemplary embodiment, a liquid-cooled first jacket water aftercooler 24 can be fluidly configured in parallel with a liquid-cooled CGI cooler and a liquid-cooled engine oil cooler. In another exemplary embodiment, a liquid-cooled second jacket water aftercooler 26 can be fluidly coupled in series with a pump 108. Pump 108 may be fluidly coupled in series with a group including first jacket water aftercooler 24, a liquid-cooled CGI cooler, and a liquid-cooled engine oil cooler configured in parallel with respect to each other.

FIG. 3 illustrates an exemplary machine 200, such as an off-highway truck. Machine 200 may comprise a frame 212 and a dump body 214 pivotally mounted to the frame 212. An operator cab 216 may be mounted on the front of the frame 212 above an engine enclosure 218. Machine 200 may be supported on the ground by a pair of front tires 220 (one shown) and a pair of rear tires 222 (one shown).

One or more engines 10 may be located within engine enclosure 218. Engine 10 may be used to provide power to a drive assembly of machine 200, via a mechanical or electric drive train.

### INDUSTRIAL APPLICABILITY

The disclosed air intake system including a multi-stage jacket water aftercooler 44 may have applicability with internal combustion engines. In particular, as illustrated in FIG. 1, the air intake system 38, implementing aftercooler 44, can serve to cool a mixture of pressurized air and recirculated exhaust gas that can be introduced into an air intake of a power source 10. The operation of an air intake system for a power source including a first jacket water aftercooler, a second jacket water aftercooler, a compressor system and an air intake for the power source will now be explained.

During operation of machine 200, a power source 10 produces combustion gasses that may include harmful emissions. To improve combustion efficiency and reduce harmful emissions of a power source 10, a portion of exhaust gas from the exhaust system 37 may be recirculated to an air intake system 38 of power source 10. For example, at least one turbocharger can be fluidly connected to air intake port 42, air intake system 38, CGI system 36, and the exhaust system 37, and configured to provide a mixture of pressurized air and recirculated exhaust gas from the exhaust system 37 to aftercooler 44 and, ultimately, to power source intake port 42. The disclosed aftercooling system 44 includes first and second jacket water aftercoolers 24 and 26 fluidly upstream from the air intake for the power source and fluidly downstream from the compressor system. First and second jacket water aftercoolers 24 and 26 may be configured to cool the mixture of pressurized air and recirculated exhaust gas.

Several advantages over the prior art may be associated with the disclosed air intake system. For example, because typical ATAACs are constructed from materials like aluminum, they can be more susceptible to corrosion and wear from acid condensates. An exemplary disclosed air intake system replaces the ATAAC with an aftercooler 44 that includes a first jacket water aftercooler 24 and a second jacket water aftercooler 26. Jacket water aftercoolers 24 and 26 can be constructed from materials more resistant to corrosion (e.g., stainless steel, etc.), which can make them more durable and less susceptible to corrosion and wear from acid condensates. Additionally, aftercooler 44 can be configured to provide two-stage aftercooling of a mixture of pressurized air and recirculated exhaust gas by providing lower temperature cooling fluid from radiator 104 to second jacket water aftercooler 26 and by providing higher temperature cooling fluid from thermostat 102 that bypasses radiator 104 and then providing cooling fluid from second jacket water aftercooler 26 to first jacket water aftercooler 24. The two-stage aftercooling provides a way of taking advantage of two sources of coolant, the radiator and the thermostat bypass, to provide efficient cooling of the mixture of pressurized air and recirculated exhaust gas.

It will be apparent to those skilled in the art that various modifications and variations can be made to the disclosed air intake system. Other embodiments will be apparent to those skilled in the art from consideration of the specification and practice of the disclosed air intake system. It is intended that the specification and examples be considered as exemplary only. Accordingly, the disclosed embodiments are not limited to the described examples, but instead are defined by the appended claims in light of their full scope of equivalents.

What is claimed is:

1. An air intake system for a power source, comprising:
a first jacket water aftercooler;
a second jacket water aftercooler;
a compressor system; and
an air intake for the power source;
wherein the first jacket water aftercooler and the second jacket water aftercooler are located fluidly upstream from the air intake for the power source and fluidly downstream from the compressor system.

2. The air intake system according to claim 1, wherein the first jacket water aftercooler is fluidly coupled in series with the second jacket water aftercooler.

3. The air intake system according to claim 1, wherein the first jacket water aftercooler and the second jacket water aftercooler are fabricated from materials including stainless steel.

4. The air intake system according to claim 1, wherein the compressor system includes a first compressor and a second compressor, and wherein the first compressor is fluidly coupled in series with the second compressor.

5. The air intake system according to claim 1, wherein the pressure drop between the air intake of the power source and a point downstream from the compressor system is no greater than about 15 KPa.

6. The air intake system according to claim 1, further including:
a clean gas induction system; and
an exhaust system;
wherein the intake system is fluidly coupled to the clean gas induction system, and the clean gas induction system is fluidly coupled to the exhaust system.

7. The air intake system according to claim 1, further including:
a cooling system including at least one radiator, a thermostat, a modular orifice, an oil cooler, and a clean gas induction cooler;
wherein the first jacket water aftercooler, the engine oil cooler, and the clean gas induction cooler are fluidly coupled in parallel with respect to a flow of a coolant fluid.

8. A method for cooling airflow fluidly upstream of an air intake for a power source and fluidly downstream from a compressor system, comprising:
introducing a mixture of pressurized air and recirculated exhaust gas to an aftercooling heat exchanging system via one or more pressurized air and recirculated exhaust gas passages;
wherein the one or more exhaust gas passages are fluidly coupled to the heat exchanging system, and wherein the heat exchanging system includes a first jacket water aftercooler and a second jacket water aftercooler; and
aftercooling the mixture with the heat exchanging system.

9. The method according to claim 8, further including introducing the aftercooled mixture to an air intake for the power source.

10. The method according to claim 8, wherein introducing a mixture of pressurized air and recirculated exhaust gas to an aftercooling heat exchanging system includes controllably introducing a quantity of exhaust gas from an exhaust clean gas induction (CGI) system.

11. The method according to claim 10, wherein the CGI system includes a low pressure loop CGI system.

12. The method according to claim 8, wherein the first jacket water aftercooler is fluidly coupled in series with the second jacket water aftercooler.

13. The method according to claim 8, further including maintaining a pressure differential of no more that about 15 KPa between the air intake for the power source and a point fluidly downstream from a compressor system.

14. A machine comprising:
a power source; and
an air intake system for the power source comprising:
a first jacket water aftercooler;
a second jacket water aftercooler;
a compressor system; and
an air intake for the power source;
wherein the first jacket water aftercooler and the second jacket water aftercooler are located fluidly upstream from the air intake for the power source and fluidly downstream from the compressor system.

15. The machine according to claim 14, wherein the first jacket water aftercooler is fluidly coupled in series with the second jacket water aftercooler.

16. The machine according to claim 14, further including:
an exhaust system; and
a clean gas induction system;
wherein the intake system is fluidly coupled to the clean gas induction system, and the clean gas induction system is fluidly coupled to the exhaust system.

17. The machine according to claim 14, wherein the compressor system includes a first compressor and a second compressor, and wherein the first compressor is fluidly coupled in series with the second compressor.

18. The machine according to claim 14, wherein the compressor system includes a two-stage compressor.

19. The machine according to claim 14, further including
a cooling system including at least one radiator configured to provide coolant to the second jacket water aftercooler; and
at least one thermostat bypass fluidly coupled to at least one modular orifice and configured to provide coolant to the first jacket water aftercooler.

20. The machine according to claim 14, wherein the first jacket water aftercooler and the second jacket water aftercooler are fabricated from materials including stainless steel.
